(19) United States
(12) Patent Application Publication
(10) Pub. No.: US 2004/0177446 A1
(43) Pub. Date: Sep. 16, 2004

(54) Child support device

(76) Inventors: Sandra Leigh Robb, Perth (AU); Margareth Thullan Lillebeth Curran, City Beach (AU)

Correspondence Address: DOUGHERTY, CLEMENTS & HOFER, 1901 ROXBOROUGH ROAD, SUITE300, CHARLOTTE, NC, 28211, US

(21) Appl. No.: 10/729,117

(22) Filed: Dec. 5, 2003

Related U.S. Application Data
(63) Continuation-in-part of application No. PCT/AU02/00730, filed on Jun. 5, 2002.

(30) Foreign Application Priority Data
Jun. 6, 2001 (AU) PR 5503

(51) Int. Cl. B68G 5/00

(52) U.S. Cl. 5/655; 5/420

(57) ABSTRACT

A child support device (10) comprising a base section (12) to provide a resting area (14) for a child (16). A harness means (18) is attached to the base section (12) to retain the child within the resting area. The base section (12) is laterally rigid so that the device (10) remains stable when the child is harnessed within the resting area (14). The base section comprises a first section (26), a second section (28) and a head section (30).

### CROSS REFERENCE TO RELATED APPLICATION

This application claims the benefit of International Patent Application No. PCT/AU02/00730, filed on Jun. 5, 2002, further claiming priority of Australian Provisional Patent Application No. PR 5503, filed on Jun. 6, 2001 pursuant to M.P.E.P. § 201.11 (a).

### FIELD OF THE INVENTION

The invention relates to a child support device.

The invention has been devised particularly although not solely for use in relation to young children under 18 months of age.

### BACKGROUND

It is often necessary to support and restrain young children for a number of reasons including for nappy changing, feeding, amusement and safety.

A number of prior art devices are known which are designed to support and restrain young children for the above reasons.

However, difficulties have been encountered with these prior art devices for safety reasons. The devices are often not provided with adequate restraining systems to prevent the child from rolling out of the device. Furthermore, some of the devices may roll up on themselves on movement of the child causing a safety risk. Many of the prior art devices are bulky and difficult to assemble or transport.

The present invention attempts to at least partially overcome some of the above difficulties.

### SUMMARY OF THE INVENTION

The present invention provides a child support device comprising a base section to provide a resting area for a child and a harness means attached to the base section to retain the child within the resting area, the base section comprising first and second base sections angularly moveable with respect to each other whereby the second section can function as a back rest when angularly offset with respect to the first section, the second section being laterally rigid so that the device remains stable when the child is harnessed within the resting area.

When the child is held by the harness means within the resting area, the lateral rigidity of the base section prevents the child from rolling over sideways. The lateral rigidity also retains the device in a firm position and prevents the device from rolling up into a sausage shape on movement of the child.

Preferably, the base section presents a cushioned support surface on which the child may rest.

The base section preferably comprises an upper layer and a lower layer. The upper layer is preferably formed of soft material to present the cushioned surface. The lower layer is preferably formed of material substantially more rigid than the upper layer to provide the stability. The upper layer may typically be a soft foam, a foam composition or like cushioning material. The lower layer of the second section may typically be a thin board material.

The base section may be enclosed in a base cover means. The base cover means may conveniently be plastic or other liquid impermeable material for ease of cleaning.

The second section is preferably adjacent the first section. The first section is preferably hingedly connected to the second section at a first junction. Alternatively, the first section and the second section may not necessarily be connected and may be formed as separate components which are held together in close proximity within the base cover means.

In one form of the invention, only the second section is laterally rigid, the first section being at least partially flexible. In this arrangement, the overall lateral rigidity of the base section is maintained whilst reducing the weight of the device. In this form, manufacture of the device may be cheaper and easier due to the need for a reduced amount of firm material used to form the lower layer.

The second section may be layered with an upper layer of soft material and a lower layer of material substantially more rigid than the upper layer to provide overall lateral rigidity to the second section. In this form the first section may be generally of softer material to provide comfortable cushioning for the child and does not need to be layered like the second section.

The first and second sections may be of generally rectangular shape and suitably dimensioned so that when the sections are connected they may form a generally rectangular arrangement of a shape and size to comfortably accommodate a young child.

The first base section may comprise two portions foldably connected together such that one portion can be folded into a position below the other. This is advantageous in that in the folded condition the overall size of the first section is reduced so that it can be accommodated in a child carrier portion of a conventional shopping cart or trolley.

The first and second sections may be arranged in various angular positions relative to each other. In a first condition, the first and second sections may be substantially planar to provide a flat surface so that the child may rest in the lying down position such as for nappy changing.

In a second condition, the second section may be positioned in a generally upright position such as when using the device on a chair. In this condition, the device provides a high chair for the child which can be placed on a conventional chair. A variation to this condition is possible where the first section is formed in two parts foldably connected together, as referred to above. One part can be folded into a position below the other part, thereby reducing the overall “foot print” area of the first base section.

In a third condition, the second section may be disposed at an obtuse angle to allow positioning of the device in a reclining position for example when the second section is supported by a cushion. In this way, the device may be used as a bouncinette for the child.

In a fourth condition, the first section and the second section may be folded about each other to allow compact flat storage of the device or to allow transporting of the device.

The base section may further comprise a head section adjacent the second section on which the head of the child may rest. The head section and the second section may be hingedly connected at a second junction.

The head section is preferably in the form of soft cushioning for comfort and is not layered like the base section.

The head section is preferably of a rounded shape and dimensioned of a suitable size for positioning of the head of the child.

The harness means is conveniently in the form of first strap means. The first strap means may comprise a pair of sash straps adapted to be positioned crosswise over the trunk of the child.

Each sash strap preferably comprises two strap sections adapted to be fitted together. This allows for fastening and unfastening of each sash strap. Each sash strap may further comprise an adjusting means such as an adjustable clasp to clasp the two strap sections together and to allow for adjustment of the lengths of the sash straps if necessary.

In one arrangement, a first end of the first sash strap may be positioned on the second section of the base section remote from the first junction and the opposing end of the first sash strap may be positioned on an opposed side of the second section of the base section proximate the first junction. The second sash strap may be positioned in an opposing manner to that of the first sash strap such that the two sash straps are in a crossed array. In use, the crossed array of the sash straps preferably passes over the trunk of the child to secure the child within the resting area of the device.

In this arrangement, the pair of sash straps straddle the second section of the base section.

Thus, in one form of the invention, the sash straps straddle the second section of the base section. The second section is preferably layered and laterally rigid, and the first section is formed of soft cushioning. In this way, the upper body of the child is securely retained within the resting area adjacent the second section, the lateral rigidity of the second section ensuring that the device does not roll up on itself in a sausage shape when the child moves.

This form of the invention is also convenient for use in the second condition since the second section forms an rigid upright surface against which the back of the child may rest. In a similar way, the second section provides a firm support for the upper body of the child when the device is used in the third condition.

In an alternative arrangement, a first end of the first sash strap may be positioned on the second section of the base section remote from the first junction and the opposing end of the first sash strap may be positioned on an opposed side of the first section of the base section proximate the first junction. The second sash strap may be positioned in an opposing manner to that of the first sash strap such that the two sash straps are in a crossed array.

The sash straps may be secured by a clasping means at the crossover point between the straps to retain the straps in a secure crossed arrangement and to retain the sash straps away from the neck of the baby. The clasping means is generally appropriate for use when the device is used in the first condition.

The strap means may further comprise a central strap located on the first section adapted to be connected to the sash straps. The central strap may typically be provided with fastening means to fasten the central strap in position over the sash straps.

Once the child is secured by the two sash straps, the central strap may be passed between the legs of the child and fastened over the sash straps to provide extra support to retain the child in the resting area. Use of the central strap is preferable when the device is used in the second condition for example on a chair, or in the third condition in a reclining position to assist in safely retaining the child within the resting area of the device.

The harness means may be adapted to allow the device to be carried in the form of a backpack when the device is in the fourth condition. Thus, the sash straps may be released from the crossed array by means of the adjusting means in the form of adjustable clasps. The strap sections are then clasped together again so that the strap sections on the same side of each base section are joined. In this way, the sash straps may form shoulder straps to allow carrying of the device as a backpack.

The device may further comprise support means, typically in the form of a detachable support strap. One end of the support strap may be positioned on the base section adjacent the first junction and the other end of the support strap may be positioned on an opposing side of the base section adjacent the first junction.

The support strap may be placed around the object on which the device is resting to provide extra stability to the device, for example in the case of use on a chair around the back of the chair. The support strap may be conveniently provided in two support portions connected by means of a connecting means such as a clasp.

The support strap may also function as a shoulder strap to carry the device when in the folded condition as will be explained later.

Alternatively, the support means may be in the form of second strap means. Preferably the second strap means comprises two straps which may be elasticised. The first ends of the two straps are preferably positioned on a first side of the second section and the second ends of the two straps are positioned on an opposing second side of the second section.

Thus, when the device is used in the second condition the two straps may be secured around the back of a chair to secure the device in position on the chair.

The invention further provides a child support device comprising a base section to provide a resting area for a child, the base section comprising an inner section and an outer cover means, the inner section being received within the outer cover means, and a harness means attached to the base section to retain the child within the resting area, the base section comprising first and second sections angularly moveable with respect to each other whereby the second section can function as a back rest when angularly offset with respect to the first section, the second section being laterally rigid so that the device remains stable when the child is harnessed within the resting area. The base section preferably presents a cushioned surface on which the child may rest. The base section preferably comprises an upper layer and a lower layer. The upper layer preferably comprises soft material to present the cushioned surface. The lower layer of the second section preferably comprises a material substantially more rigid than the upper layer.

The outer cover means is preferably provided with a cover opening into which the inner section may be inserted.

The outer cover means is preferably of similar dimension to that of the inner section so that the inner section fits snugly into the outer cover means.

The inner section preferably comprises a first section and a second section adjacent the first section. The first section may be hingedly connected to the second section via a first junction. Alternatively, the first section and second section may be formed as separate components which are held in close proximity within the outer cover means.

The base section may further comprise a head section hingedly connected to the second section via a second junction.

The harness means may be in the form of first strap means, typically a pair of sash straps adapted to be positioned crosswise over the trunk of the child.

The strap means may further comprise a central strap adapted to be connected to the sash straps.

The base section may be further provided with a support strap. One end of the support strap may be positioned on the base section adjacent the first junction and the other end of the support strap may be positioned on an opposing side of the base section adjacent the first junction. For convenience, the support strap may be detachable from the outer cover means for example by means of a clip and loop system.

The invention also provides a child support device comprising a base portion to provide a resting area for a child, the base portion comprising a first base section and a second base section, and a harness means attached to the base portion to retain the child within the resting area, the second base section being laterally rigid so that the device remains stable when the child is harnessed within the resting area.

Preferably the base portion presents a cushioned surface on which the child may rest. The second base section preferably comprises an upper layer and a lower layer. The upper layer is preferably comprised of soft material to present the cushioned surface. The lower layer is preferably formed of material substantially more rigid than the upper layer to provide rigidity and stability.

The first base section is preferably in the form of soft cushioning for comfort and is not layered like the second base section.

Preferably the first base section is adjacent the second base section. The first base section and the second base section are preferably hingedly connected at a first junction.

Preferably the device further comprises a head section adjacent the second base section. The head section and the second base section are preferably hingedly connected at a second junction.

The harness means is conveniently in the form of first strap means which may comprise a pair of sash straps which are positioned in a crossed array over the child to secure the child in the resting area.

The child support device is designed to be conveniently folded into a compact shape. Folding of the device typically occurs about the first and second junctions.

The base section may be provided with a closure means to enable the device to be folded together to form a compact bag shape. In this form the harness is typically retained inside the folded first and second sections of the device for tidiness. The closure means preferably comprises a first closure portion and a second closure portion. The first closure portion is preferably located on the head section and is adapted to engage with the second closure portion which may be located on the first section.

The first closure portion may typically be a strap with a portion of Velcro which may engage with the second closure portion which is in the form of a corresponding piece of Velcro.

Transporting the device preferably entails folding the first section towards the second section about the first junction. The harness and head section are retained between the folded sections and the first closure portion and the second closure portion are sealed to form a closed unit. The closed unit may be carried by attaching the support strap to the unit and using the support strap as a shoulder strap.

The outer cover means may be provided with additional useful features such as pockets or clips for holding such items as bottles, toys, food and baby nappies.

The base section may further comprise a cushion attachment means whereby a cushion may be attached to the device. The cushion attachment means may be for example a pocket in which a deflated cushion resides. When the device is used in the second condition, the cushion may be inflated as needed to provide further height for seating of the child. The cushion attachment means is preferably located on the first section.

The base section may also be provided with connecting means to allow the device to be releasably attached to a compatible bag. In one arrangement, the connecting means may comprise a zipper where one half of the zipper is provided on the base section in a suitable position and the other half of the zipper is provided on the bag. In another arrangement, the connection means may comprise an array of clasps, such as press studs or magnetically connected studs.

In this way the folded device may be attached to the bag, for example a baby bag holding baby accessories such that the device and bag may be transported as a single unit. As an alternative option, the bag may be used to transport the folded device within the interior of the bag.

In a further arrangement, the device may be carried in the form of a back pack. In this form, the device is folded along the first junction and closed by means of the closure means. The sash straps are retained on the outside of the device to allow attachment of the straps to the shoulders of a user. The sash straps are adjusted from the crossed array to a straight arrangement to form shoulder straps for the user.

Thus it can be seen that the child support device is a versatile device that may be readily adapted for use as a changing mat, a support for resting on a seat or in an angled formation as a bouncinette. Furthermore, the device may be conveniently carried in a number of ways, such as by simply folding in a flat arrangement, by means of a shoulder strap, in association with a bag, or in the form of a back pack.

### BRIEF DESCRIPTION OF THE DRAWINGS

The invention will be better understood by reference to the following description of various embodiments thereof as shown in the accompanying drawings in which:

FIG. 1 is a schematic view of a child support device according to a first embodiment (excluding the harness);

FIG. 2 is a sectional side view of the device shown in FIG. 1;

FIG. 3 is a cross-section along the line 3-3 of FIG. 1;

FIG. 4 is a perspective view of the child support device according to the first embodiment;

FIG. 5 is a perspective view of the child support device according to a second embodiment in a first condition;

FIG. 6A is a perspective view of the child support device of FIG. 5 in use supporting a child;

FIG. 6B is a perspective view of the child support device of FIG. 5 showing use of a clasping means;

FIG. 7 is a perspective view of the reverse side of the child support device of FIG. 5;

FIG. 8 is a perspective view of the child support device according to the second embodiment in a second condition;

FIG. 9 is a perspective view of the child support device of FIG. 8 in use supporting a child;

FIG. 10 is a perspective view of the child support device of FIG. 8 in use supporting a child and used in association with a cushion;

FIG. 11 is a perspective view of the child support device according to the second embodiment in a third condition;

FIG. 12 is a perspective view of the child support device of FIG. 11 in use supporting a child;

FIG. 13 is a perspective view of a child support device according to a third embodiment in a second condition;

FIG. 14 is a perspective view of the child support device according to the third embodiment in a fourth condition;

FIG. 15 is a perspective view of the child support device according to the third embodiment in the fourth condition and attached to a bag;

FIG. 16 is a perspective view of the child support device according to the third embodiment positioned inside the bag;

FIG. 17 is a perspective view of the child support device according to the third embodiment carried in the form of a back pack;

FIG. 18 is a perspective view of the child support device according to a fourth embodiment;

FIG. 19 is a perspective view of the child support device according to the fourth embodiment in a fourth condition and attached to a bag;

FIG. 20 is a perspective view of the child support device according to a fifth embodiment;

FIG. 21 is a further perspective view of the child support device of FIG. 20; and

FIG. 22 is a perspective view of the device of FIG. 20 folded for transportation.

### DETAILED DESCRIPTION

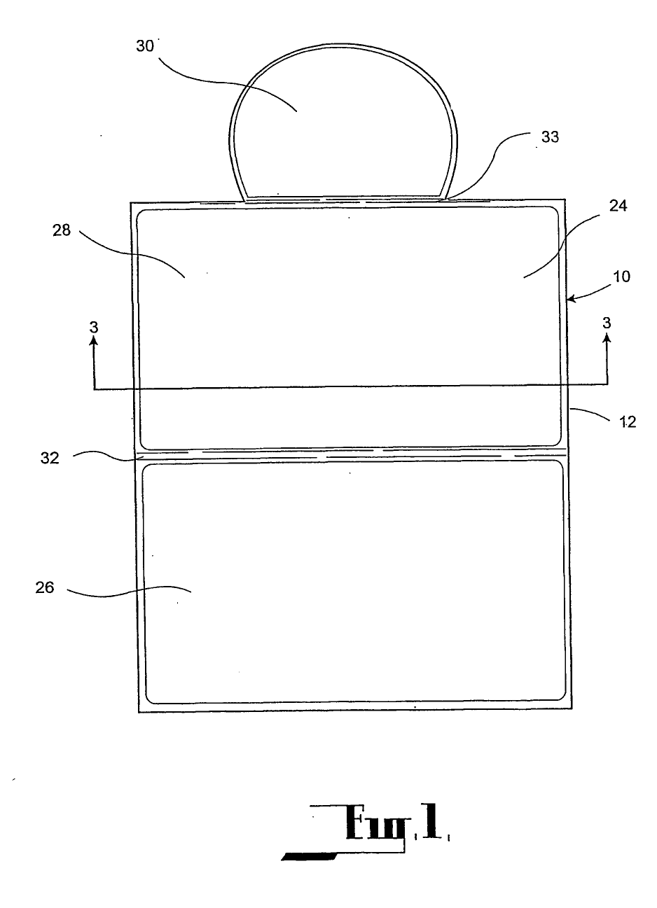

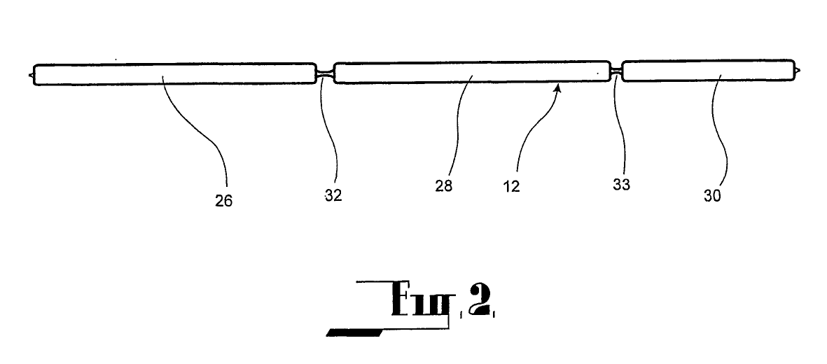

Referring now to FIGS. 1 to 16 of the accompanying drawings, there is shown a child support device 10 comprising a base section 12 which defines a resting area 14 for a child 16. The device also comprises a harness means 18.

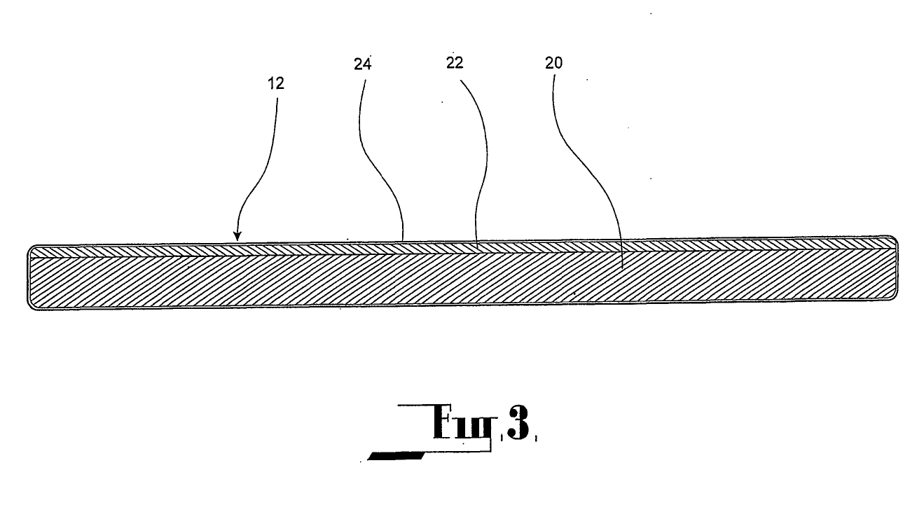

The base section comprises an upper layer 20 and a lower layer 22 as shown in FIG. 3. The upper layer 20 is formed of soft foam material which presents a cushioned surface on which the child 16 is supported. The lower layer 22 is in the form of a thin wooden board.

Since the lower layer 22 is of a material which is substantially more rigid than the upper layer 20, the base section 12 is laterally rigid which retains the device 10 in a firm position. The lateral rigidity also prevents the device 10 from rolling up on itself on movement of the child.

The base section 12 is enclosed in a base cover means 24 which is formed of plastic material which can be easily wiped for cleaning purposes.

As shown in the first embodiment in FIG. 4, a harness means 18 is attached to the base section 12 for retaining the child. In this form which has particular application in a hospital or other like environment, the base section presents a clean surface on which the baby can be supported. Given that the base cover means 24 is made of a plastic material, it can be easily sterilised and cleaned.

The base section 12 comprises a first section 26, a second section 28 and a head section 30. The first and second sections are hingedly connected together at a first junction 32. The second section 28 and the head section 30 are hingedly connected together at a second junction 33.

In a variation of the first embodiment (not shown in the drawings), only the second section 28 is laterally rigid and is comprised of an upper layer 20 and a lower layer 22. In this variation, the first section 26 and the head section 30 is comprised of soft foam material.

The harness means 18 is in the form of two sash straps 34 comprised of two strap sections 36. The strap sections 36 are connected together and length adjustable by means of an adjustable clasp 37. As can be seen in FIG. 4, a first end 38 of one of the sash straps 34 is positioned on the second section 28 of the base section 12 remote from the first junction 32 and the opposing end 40 of the strap is positioned on an opposed side of the second section 28 of the base section proximate the first junction 32.

The second sash strap 34 is positioned in an opposing manner to that of the first sash strap 34 such that the two sash straps 34 are in crossed array as shown in FIG. 4. In use, the crossed array passes over the trunk of the child to secure the child within the resting area of the device.

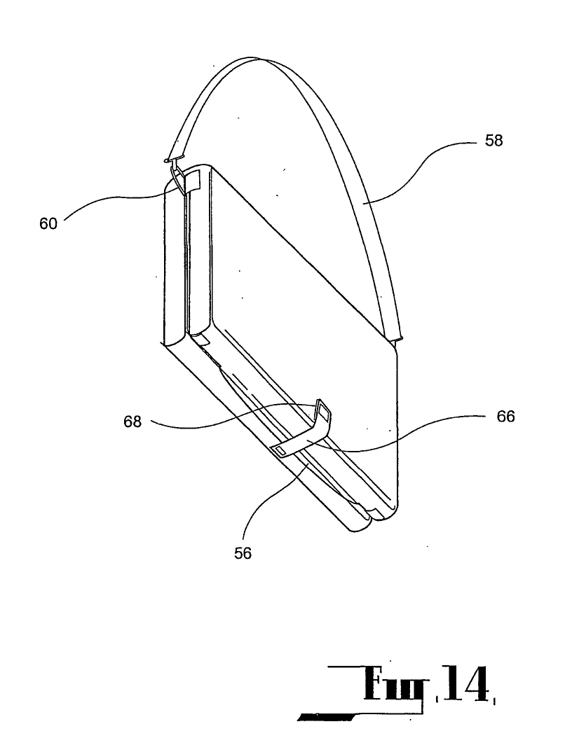

The harness means 18 further comprises a central strap 42 located on the first section 26. The central strap 42 is provided with fastening means 44 to fasten the central strap in position over the sash straps 34 as shown in use in FIGS. 9 and 12.

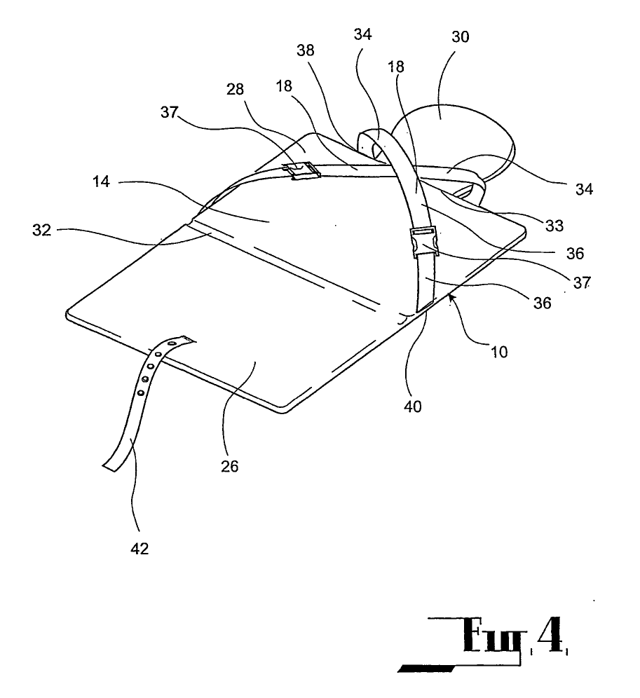

The device of the second embodiment resembles that of the first embodiment in many ways except that the two sash straps 34 are positioned in an opposing manner between the first and second sections of the base section as can be seen in FIG. 5.

The device 10 according to the second embodiment comprises a base section 12 with an outer cover means 46 of material and an inner section 48 (not visible in the drawings) which is received within the outer cover means 46.

The outer cover means 46 comprises a cover opening (not shown) into which the inner section 48 is inserted. The outer cover means 46 is of similar dimension to that of the inner section 48 so that the base section fits snugly into the outer cover means 46. In a variation of the second embodiment, the inner section 48 may be comprised of two separate sections which are pushed into the outer cover means to form the first section 26 and the second section 28 of the base section respectively.

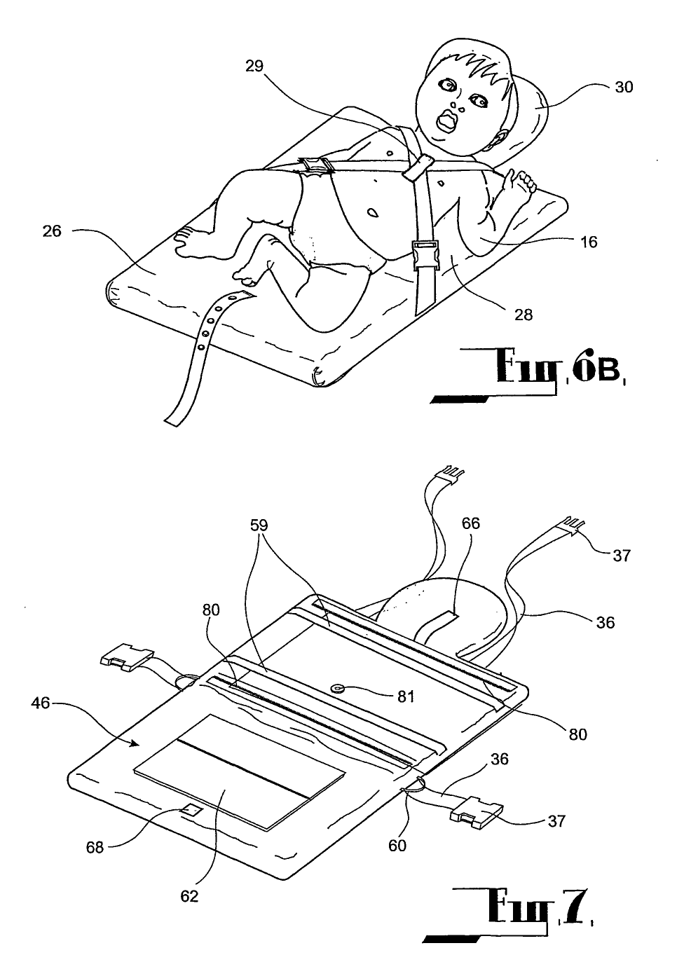

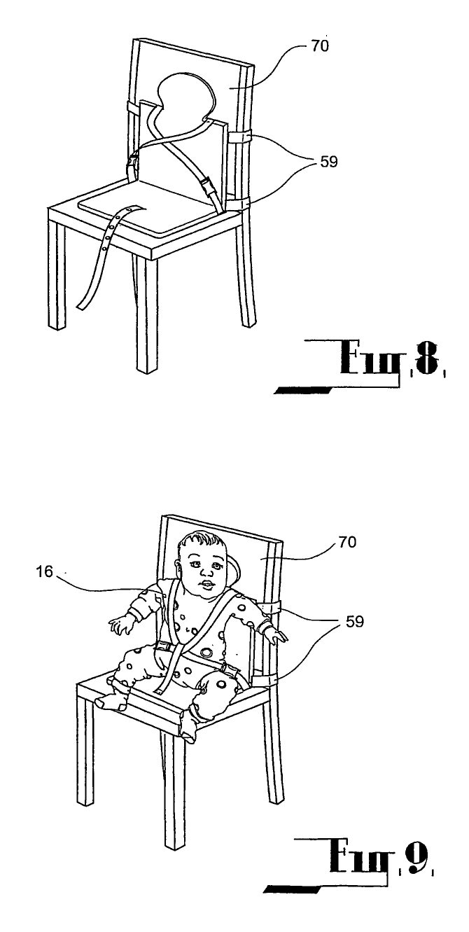

As shown in FIG. 7, the reverse side of the outer cover means 46 is provided with a storage pocket 62 and zipper means 80. The device of the second embodiment is provided with elasticised straps 59 which allow positioning of the device on a chair as shown in FIG. 8.

The device 10 is shown in use in the Figures in various conditions.

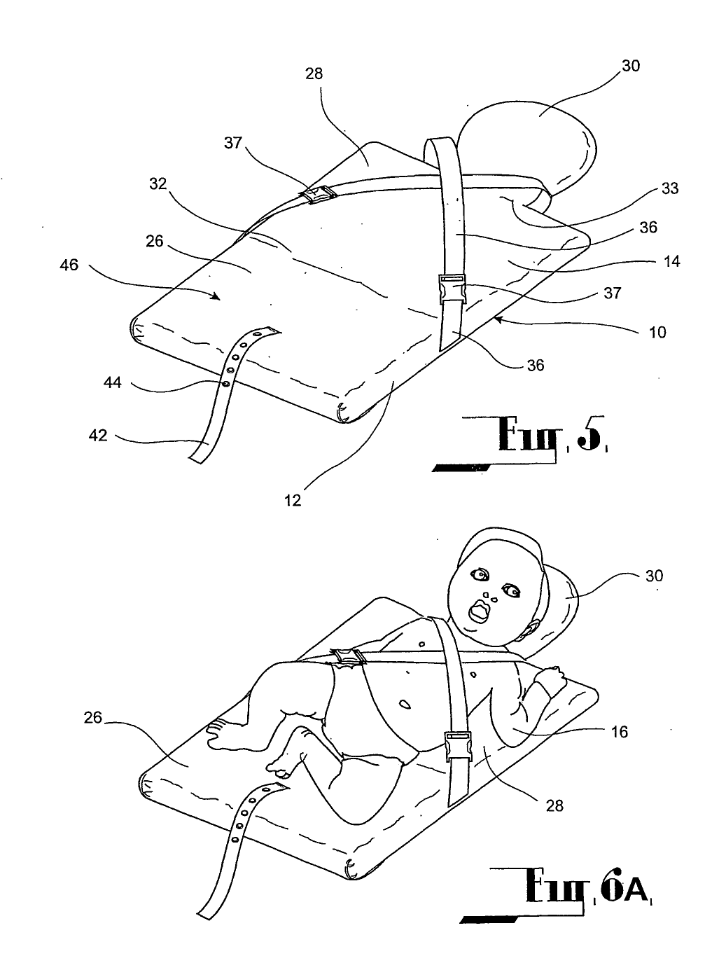

FIGS. 5, 6A and 6B show the device in use in a first condition. The first and second base sections are in planar arrangement to provide a flat surface so that the child may rest in the lying down position for nappy changing. In use, the strap sections 36 are opened and the child is placed on the resting area 14. The strap sections 36 are then closed to retain the child within the resting area to allow for example nappy changing. To assist in securing the child in the first condition and to retain the strap sections away from the neck of the child, an additional clasping means in the form of a Velcro tab 29 is affixed over the strap sections 36 as shown in FIG. 6B.

In the second condition as shown in FIGS. 8 to 10, the second section 28 and the head section 36 are positioned in a generally upright condition such as when the device 10 is in use on a chair. In this condition, the support straps 59 are used to retain the device 10 safely against the chair 70.

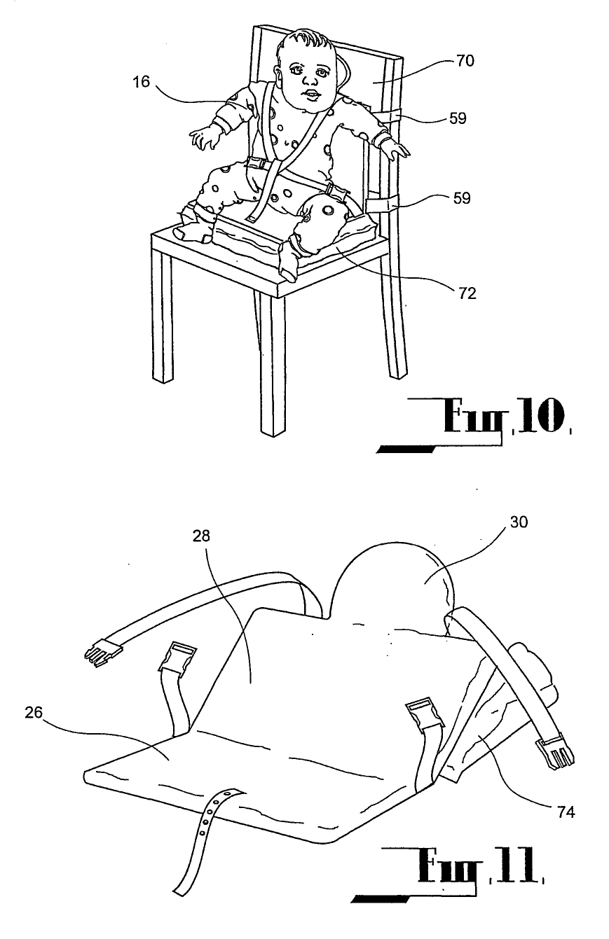

Also in the second condition, the device 10 may be used in association with a cushion 72 as shown in FIG. 10. The cushion 72 is inserted into a cushion attachment means such as a pocket (not shown) on the first cover section of the first section 26. In this way, the child may be positioned at a suitable height for example for eating.

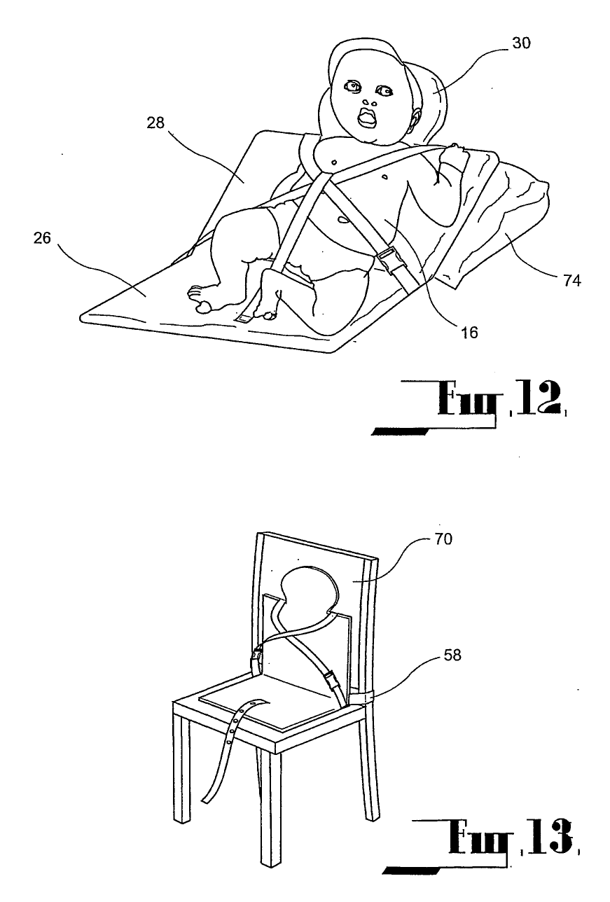

In a third condition as shown in FIGS. 11 and 12, the second section 28 is disposed at an obtuse angle to the first section 26 to allow positioning of the device 10 in a reclining position when supported by a pillow 74. In this way and as shown in FIG. 12, the device may function as a bouncinette to allow the child 16 to view the surroundings.

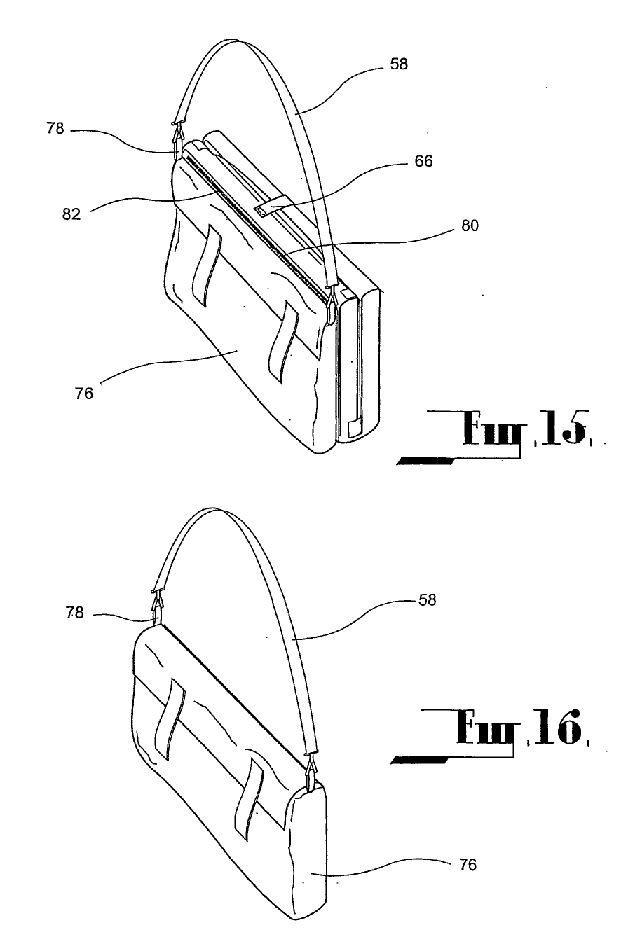

In a third embodiment which is similar in many respects to the second embodiment, the base section 12 is provided with a detachable support strap 58 as seen in use in FIG. 13. The support strap 58 may be attached or detached by means of support loops 60 as shown in FIG. 14.

As shown in FIG. 14, the device may be carried in the folded condition. In this way the first section 26 and the second section 28 are folded about the first junction 32 with the sash straps 34 and the head section 30 being retained within the two folded first and second sections. These latter sections are clamped together by means of the first closure portion 66 located on the head section 30 and the second closure portion 68 located on the first section 26. The support strap 58 is attached to the loops 60 for carrying of the device.

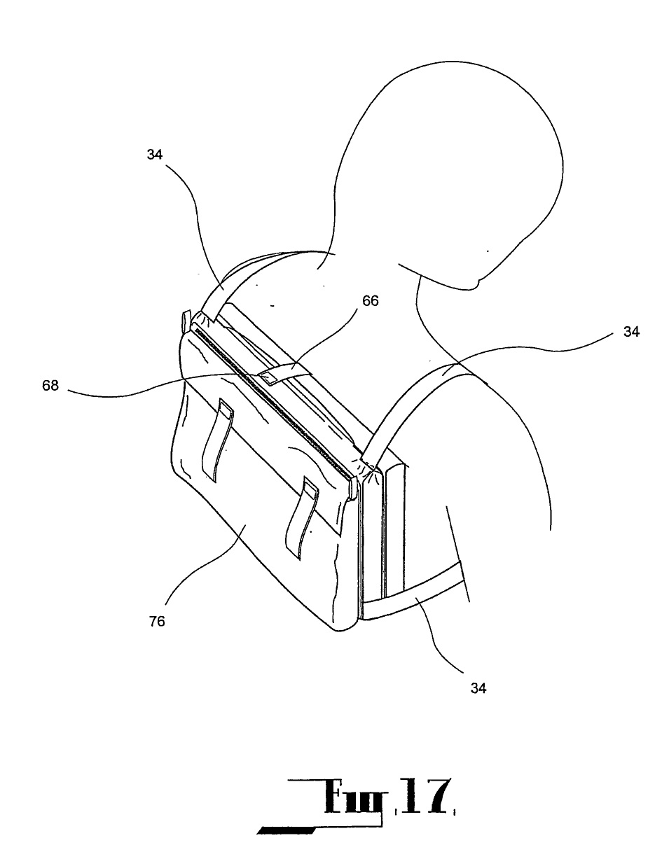

The folded form of the device is attached to a bag 76 by means of zipper means 80, the bag 76 being provided with a corresponding second zipper means 82 as shown in FIG. 15. In this form, the support strap 58 is attached to bag loops 78 to form carrying straps for the bag. The zipper means 80 is positioned in two places on the device as shown in FIG. 7 so that the device may be secured to the bag in one of two ways.

As can be seen in FIG. 7, the device is provided with a magnetic clasp which can be used together with a corresponding clasp (not shown in the Figures) positioned on the bag 76 to assist in retaining the device on the bag.

Alternatively, the folded form of the device 10 may be placed in the bag 76 when the bag is empty and the device 10 may be carried in this way as shown in FIG. 16.

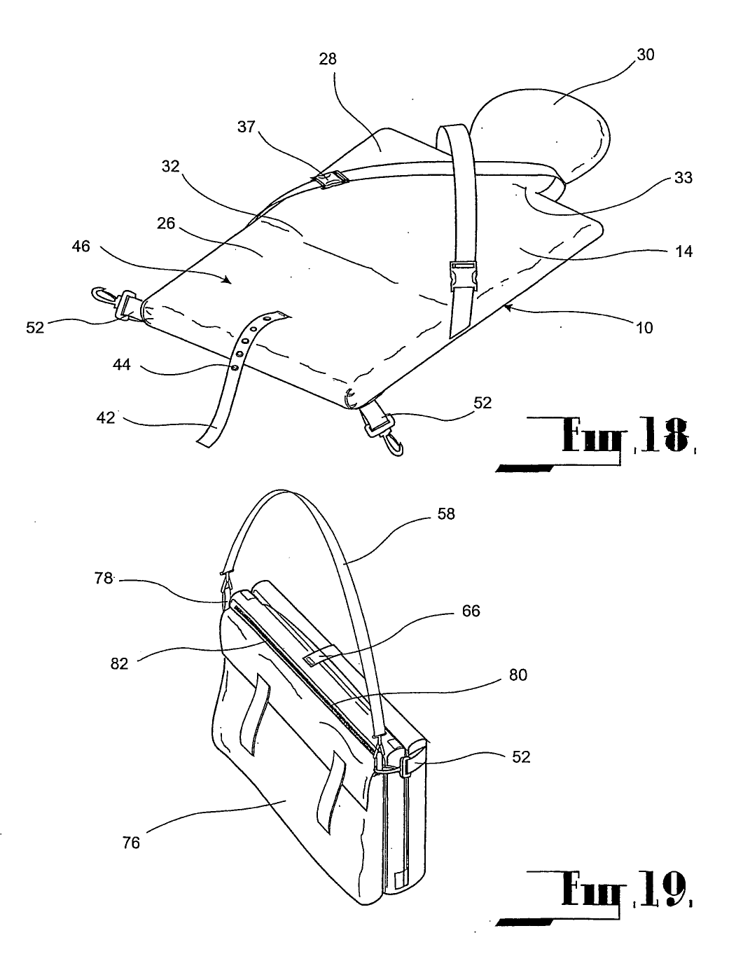

The folded device 10 may be transported in the form of a backpack. FIG. 17 shows the device 10 with the sash straps 34 removed from the crossed array to provide straight straps to form the shoulder straps of the device in the form of a backpack.

The device 10 shown in FIG. 17 is being carried as a backpack in a form as attached to a bag. The device 10 can of course also be transported on its own in the form of a backpack without being attached to a bag.

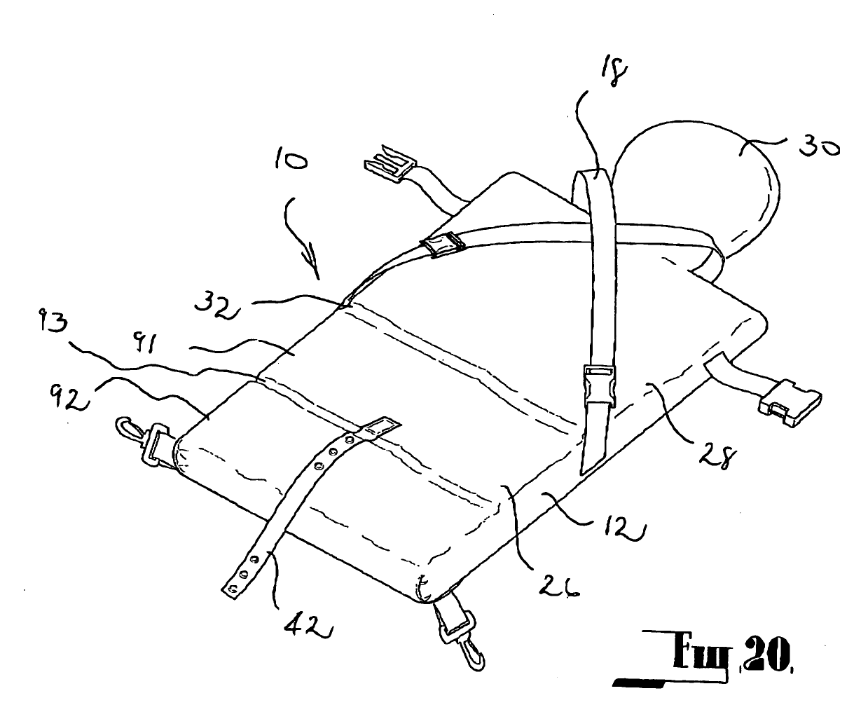

In another embodiment of the invention, the device is provided with clasps 52 as shown in FIG. 18. As can be seen in FIG. 19, these clasps 52 assist in retaining the device 10 on the bag for ease of transporting.

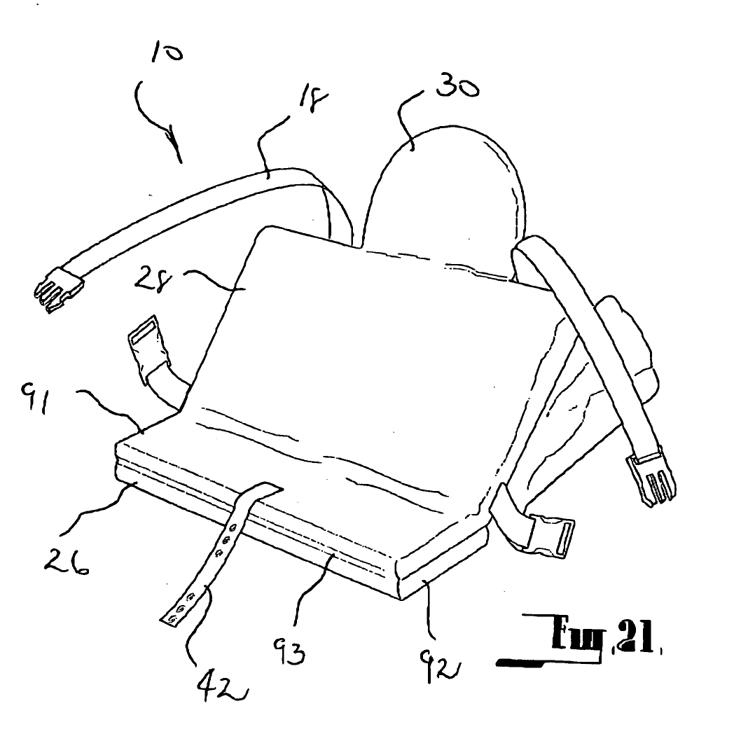

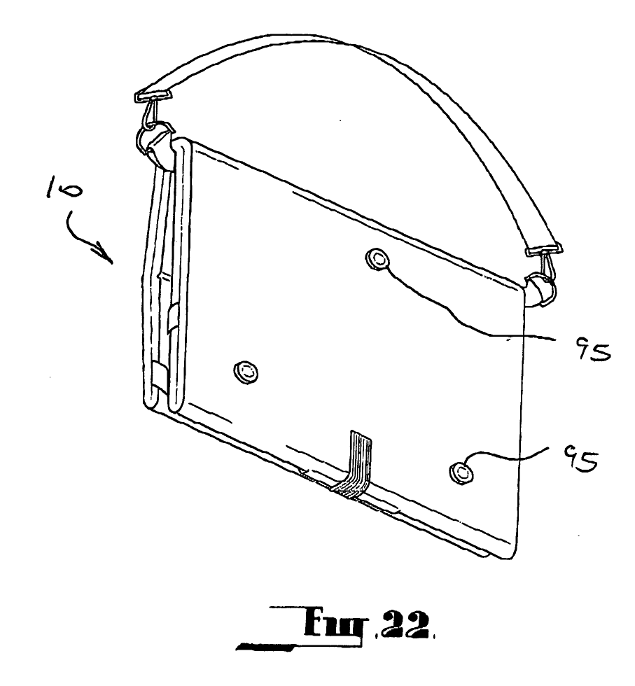

Referring now to FIGS. 20, 21 and 22, there is shown yet another embodiment. The child support device 10 according to this embodiment is similar to the first embodiment, except that the first section 26 comprises two parts, being an inner part 91 and an outer part 92 foldably interconnected at fold line 93 defined by an integral hinge therebetween. With this arrangement, the outer part 92 can be folded into a position below the inner part 91, as shown in FIG. 21. This reduces the overall “footprint” area of the first section 26, and is advantageous in that it allows the device 10 according to the embodiment to be accommodated in a child carrier portion of a conventional shopping trolley or cart, and a child supported therein in a generally upright condition (in a somewhat similar way to that shown in FIG. 9, except of course that the device is fitted into a child carrier portion of a shopping trolley or cart, and not a chair).

In this embodiment, one face of the device is provided with an array of clasp elements 95, as shown in FIG. 22. When the device 10 is in a folded condition for transportation (as shown in FIG. 22), the clasp elements 95 are exposed to receive complementary clasp elements on a bag, thereby permitting the bag to be releasably connected to the device 10. In this embodiment, the clasps comprise magnetic clasps, involving a magnetic connection between corresponding clasp elements.

Thus, it can be seen that the child support device is versatile and can be easily adapted to perform a variety of useful functions. Conveniently, the device may be easily carried in a number of compact forms.

It should be appreciated that the scope of the invention is not limited to the scope of the various embodiments described.

Throughout the specification, unless the context requires otherwise, the word “comprise” or variations such as “comprises” or “comprising”, will be understood to imply the inclusion of a stated integer or group of integers but not the exclusion of any other integer or group of integers.

What is claimed is:

1. A child support device comprising a base section to provide a resting area for a child and a harness means attached to the base section to retain the child within the resting area, the base section comprising first and second base sections angularly moveable with respect to each other whereby the second section can function as a back rest when angularly offset with respect to the first section, the second section being laterally rigid so that the device remains stable when the child is harnessed within the resting area.

2. A child support device according to claim 1 wherein the base section presents a cushioned support surface on which the child may rest.

3. A child support device according to claim 1 wherein the base section comprises an upper layer and a lower layer.

4. A child support device according to claim 3 wherein the upper layer comprises soft material to present the cushioned surface.

5. A child support device according to claim 3 wherein the lower layer of the second section comprises a material substantially more rigid than the upper layer.

6. A child support device according to claim 3 wherein the upper layer comprises foam or a foam composition.

7. A child support device according to claim 3 wherein the lower layer of the second section is formed of thin board material.

8. A child support device according to claim 1 wherein the base section is enclosed in a base cover means.

9. A child support device according to claim 8 wherein the base cover means comprises plastic or other liquid impermeable material.

10. A child support device according to claim 1 wherein the second section is positioned adjacent the first section.

11. A child support device according to claim 10 wherein the first section is hingedly connected to the second section at a first junction.

12. A child support device according to claim 10 wherein the first section and the second section may be arranged in angular alignment relative to each other.

13. A child support device according to claim 1 wherein the base section further comprises a head section adjacent the second section.

14. A child support device according to claim 13 wherein the head section is hingedly connected to the second section.

15. A child support device according to claim 13 wherein the head section is formed of soft cushioning.

16. A child support device according to claim 1 wherein the harness means is in the form of strap means.

17. A child support device according to claim 16 wherein the strap means comprises a pair of sash straps adapted to be positioned crosswise over the trunk of the child.

18. A child support device according to claim 17 wherein each sash strap comprises two strap sections.

19. A child support device according to claim 17 wherein each sash strap may further comprise an adjusting means.

20. A child support device according to claim 19 wherein the adjusting means comprises an adjustable clasp.

21. A child support device according to claim 17 wherein a first end of the first sash strap is positioned on the second section of the base section remote from the first junction and the opposing end of the first sash strap is positioned on an opposed side of the second section of the base section proximate the first junction, the second sash strap being positioned in an opposing arrangement to that of the first sash strap so that the sash straps form a crossed array.

22. A child support device according to claim 16 wherein the strap means further comprises a central strap positioned on the first section and adapted to be connected to the strap means.

23. A child support device according to claim 22 wherein the central strap is provided with fastening means.

24. A child support device according to claim 1 wherein the device further comprises support means.

25. A child support device according to claim 24 wherein the support means comprises a detachable support strap.

26. A child support means according to claim 24 wherein the support means comprises second strap means.

27. A child support device according to claim 26 wherein the second strap means comprises elasticised straps.

28. A child support device comprising a base section to provide a resting area for a child, the base section comprising an inner section and an outer cover means, the inner section being received within the outer cover means, and a harness means attached to the base section to retain the child within the resting area, the base section comprising first and second sections angularly moveable with respect to each other whereby the second section can function as a back rest when angularly offset with respect to the first section, the second section being laterally rigid so that the device remains stable when the child is harnessed within the resting area.

29. A child support device according to claim 28 wherein the base section presents a cushioned support surface on which the child may rest.

30. A child support device according to claim 28 wherein the base section comprises an upper layer and a lower layer.

31. A child support device according to claim 30 wherein the upper layer comprises soft material to present the cushioned surface.

32. A child support device according to claim 30 wherein the lower layer of the second section comprises a material substantially more rigid than the upper layer.

33. A child support device according to claim 28 wherein the base section comprises a head section.

34. A child support device according to claim 1 wherein the base section is provided with connecting means to allow the device to be attached to a compatible bag.

35. A child support device comprising a base portion to provide a resting area for a child, the base portion comprising a first base section and a second base section, and a harness means attached to the base portion to retain the child within the resting area, the second base section being laterally rigid so that the device remains stable when the child is harnessed within the resting area.

36. A child support device according to claim 35 wherein the base portion presents a cushioned surface on which the child may rest.

37. A child support device according to claim 35 wherein the second base section comprises an upper layer and a lower layer.

38. A child support device according to claim 37 wherein the upper layer is comprised of soft material.

39. A child support device according to claim 37 wherein the lower layer is comprised of a material substantially more rigid than the upper layer.

40. A child support device according to claim 35 wherein the first base section is comprised of soft material.

41. A child support device according to claim 35 wherein the device further comprises a head section adjacent the second base section.

42. A child support device comprising a base section to provide a resting area for a child and a harness means attached to the base section to retain the child within the resting area, the base section comprising first and second base sections angularly moveable with respect to each other whereby the second section can function as a back rest when angularly offset with respect to the first section, the second section being laterally rigid so that the device remains stable when the child is harnessed within the resting area, the first base section comprising two portions foldably connected together such that one portion can be folded into a position below the other.
